(19) United States
(12) Patent Application Publication
(10) Pub. No.: US 2004/0234934 A1
(43) Pub. Date: Nov. 25, 2004

(54) Educational and training system

(76) Inventors: Kevin Shin, Tacoma, WA (US); Annie Myong Hae Chan, Los Altos, CA (US)

Correspondence Address: Gergely T. Zimanyi, Sidley Austin Brown & Wood LLP, Suite 5000, 555 California Street, San Francisco, CA, 94104-1715, US

(21) Appl. No.: 10/444,754

(22) Filed: May 23, 2003

(51) Int. Cl. G09B 5/00

(52) U.S. Cl. 434/308

(57) ABSTRACT

A method of providing an electronic curriculum system is described. The method includes providing editable audio-visual assets and providing automated tools for authoring an audio-visual asset, where the authoring includes editing editable audio-visual assets and contributed audio-visual assets into authored audio-visual assets. The editable audio-visual assets can be segmented to facilitate convenient editing. In some cases the segments are intelligently tagged. The intelligent tags assist the efficient searching of the editable assets. The editable assets can be provided by an asset provider over the Internet. Authored assets can be made available for others by uploading the assets onto the servers of the asset provider. Alternatively, hyper-links can be provided to the authored assets. Reasonable review and quality control is exercised over the authored assets by the asset provider before providing access to these authored assets by others.

### BACKGROUND

1. Field of Invention

The present invention relates to electronic information authoring and distribution systems and more particularly to a method for creating an electronic curriculum.

2. Description of Related Art

Existing methods and services for the dissemination of information, for educational or entertainment purposes made impressive progress recently. New information is made available daily as instructional media in order to assist educators in improving the efficiency and quality of their instruction. Instructional media includes text, audio, visual, and graphic information. Textbooks are regularly published with accompanying CDs. Several companies are distributing videotapes for educational purposes. There is considerable expectation in the field of education that audio-visual instructional media will play an important role in the future of education.

However, the usefulness of these instructional media is limited. The students in different schools have different backgrounds, different preparation, and different interests, among others. Also, even within the same school there are honor classes, regular classes, and remedial classes. All these differences necessitate different levels of instruction.

Furthermore, teachers and educators have their own style, own preferences, and specific goals. Uniformly formatted instructional media might not fit the differing needs and expectations of students and educators. The conflict between the diversity of the needs of educators and students on one side and the uniformity of the available instructional media on the other side contributes to the limited use of instructional media in classrooms up to date.

The Internet offers a remarkable alternative, where individuals can search for specific content and select among the returns of their search according to their own preferences and needs. However, the returns of Internet searches are not well organized. There is no educational structure in the returns and no commentary by a professional educator, for example, concerning the truthfulness or the context of the results. Finally, the various results are not organized. For example, text results are not correlated with graphics or video returns. For at least these reasons, the Internet does not solve the above-described conflict.

### SUMMARY

Briefly and generally, embodiments of the invention include a method of providing an electronic curriculum system. The method includes providing editable audio-visual assets and providing automated tools for authoring an audio-visual asset, where the authoring includes editing editable audio-visual assets and contributed audio-visual assets into authored audio-visual assets.

In some embodiments the editable audio-visual assets are segmented to facilitate convenient editing. In some cases the segments are intelligently tagged. The intelligent tags assist the efficient searching of the editable assets.

In some embodiments the editable assets are provided over the Internet by an asset provider. Authored assets can be uploaded onto the servers of the asset provider to facilitate the access of others to the authored assets. In other cases, hyper-links are provided to the authored assets. Reasonable review and quality control is exercised over the authored assets by the asset provider before providing access to these authored assets by others.

### BRIEF DESCRIPTION OF DRAWINGS

For a more complete understanding of the present invention and for further features and advantages, reference is now made to the following description taken in conjunction with the accompanying drawings.

FIG. 1 is a block diagram of the steps of the method, according to an embodiment of the invention.

FIG. 2 is an exemplary illustration of the components of the various assets, according to an embodiment of the invention.

### DETAILED DESCRIPTION

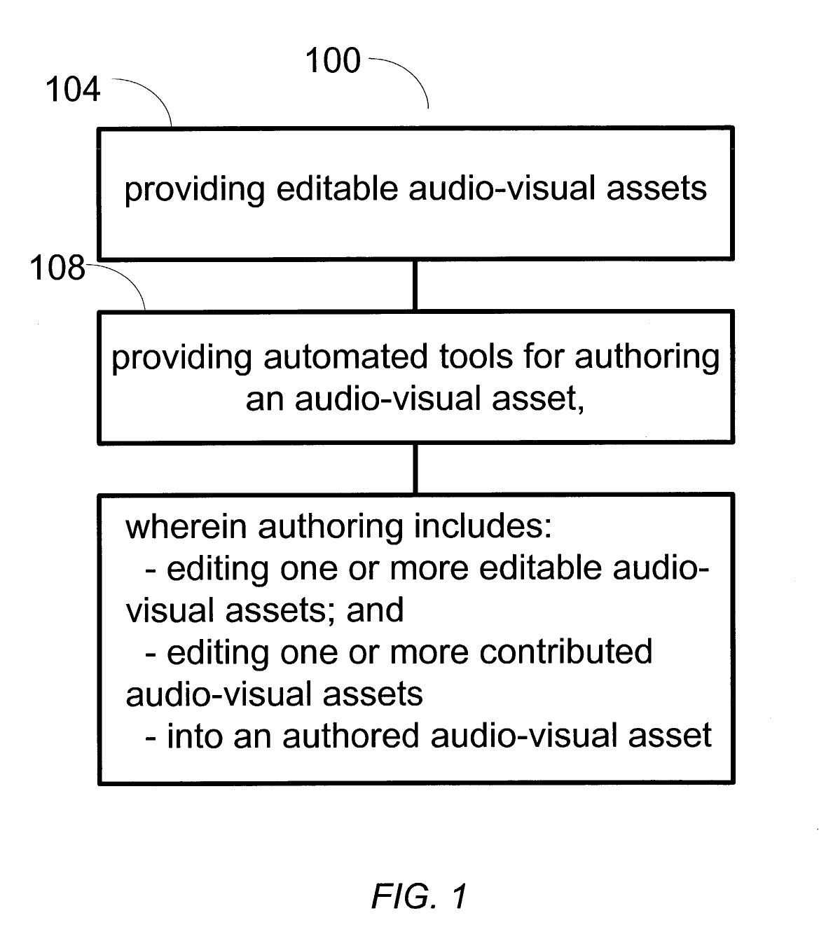

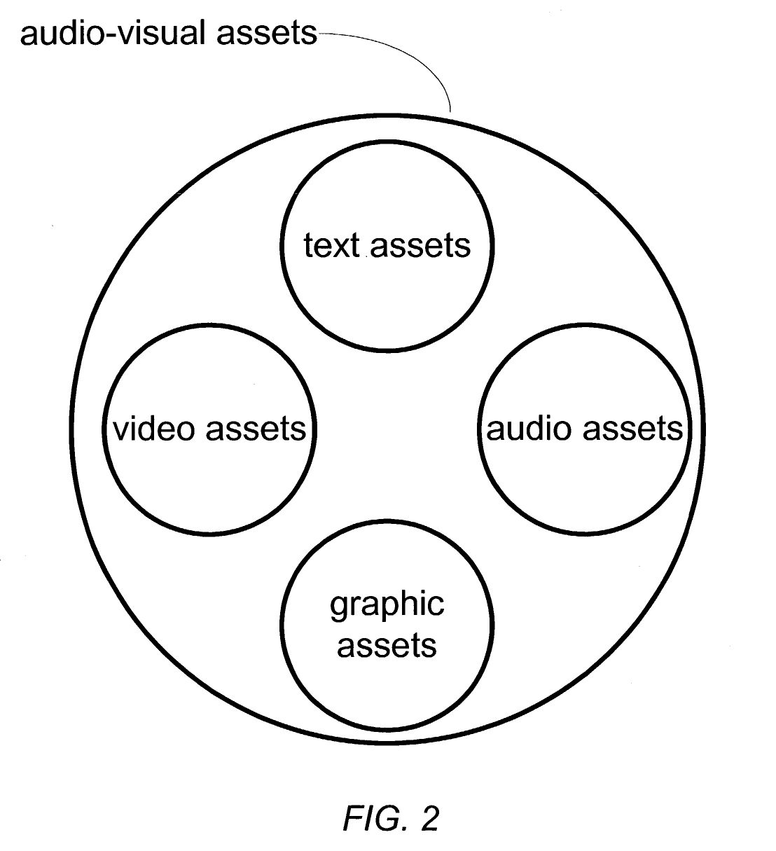

Embodiments of the present invention and their advantages are best understood by referring to FIGS. 1-2 of the drawings. Like numerals are used for like and corresponding parts of the various drawings.

FIG. 1 is a generic block diagram of a method 100 for providing an electronic curriculum system (ECS).

In step 104 editable audio-visual assets are provided.

In step 108 automated tools for authoring audio-visual assets are provided.

In step 108 the authoring includes editing one or more editable audio-visual assets and one or more contributed audio-visual assets into an authored audio-visual asset.

FIG. 2 illustrates in more detail that examples of the editable audio-visual assets in step 104 include text assets, video assets, audio assets, and graphic assets. In some embodiments the editable audio-visual assets are digitized. Digitized audio-visual assets are convenient for combination with other assets, for efficient transmission, and for applying various advanced editing techniques.

An example of the convenience of use is that digitized audio-visual assets can be compressed. Compressed assets can be efficiently transmitted on lower speed transmission lines, such as individual subscriber's phone lines and low speed modems.

Many compression techniques are known in the art. One such widely used compression format is the MPEG format.

In some embodiments of method 100 the editable audio-visual assets are provided as a DVD-Video, a DVD-ROM, or a ViDVD.

In some embodiments the editable audio-visual assets, the contributed audio-visual assets, or the authored audio-visual assets are provided in a format, which supports the authoring of audio-visual assets through editing menus and automatic tools.

In some embodiments, the editable audio-visual assets are provided by an asset provider via an Internet. The asset provider may utilize distributed servers for providing the editable audio-visual assets.

Users of the authoring tools can edit the editable assets, selecting the segments most suited for use in the electronic curriculum. The selected segments can be edited, such as linked together based on some organizing principle. In other embodiments, the selected segments are slowed down or zoomed in to allow the careful observation of a demonstrated phenomenon.

Users of the authoring tools can also contribute their own contributed assets, such as text files or charts. Contributed assets and editable assets can be combined into authored assets. For example, in some embodiments the users import the editable video assets to a box within a larger template, and include a text or a chart in another box within the same template. The text or the chart can provide instructive information, complementary to the editable video assets.

If the authored asset is of sufficient value, other users may want to access it and use it for their own presentation. Access to authored assets increases the number of options for the users of the electronic curriculum, thus enhancing the educational value of the system. The asset provider can make authored assets available for other users by uploading the authored assets to servers of the system. These uploaded authored assets are reviewed by an appropriate authority and the asset provider itself. The review at the asset provider may include an editorial review and a managerial review. Furthermore, a Quality Assessment review is also performed, to check the grammar, spelling, the links, and other aspects of the authored asset.

After the necessary modifications and improvements are implemented, the authored asset is made available by the asset provider to other users of the system. The asset provider can make available the authored assets by the Internet as editable assets.

The authored assets can be made available by uploading the authored audio-visual assets into a server. In other embodiments the asset provider provides a hyperlink or a universal resource locator on a server for the users of the system. In some embodiments the audio-visual assets can be hyper-linked to video assets.

In some embodiments the editable assets are segmented. The editable assets can be segmented into short segments. The segments can be defined by the coherence of their content. Segmented editable assets can be conveniently edited, rearranged, or searched.

Editable assets can be also intelligently tagged. For example, the segments of the editable assets can be tagged to indicate their content. In some embodiments not only the main content of the segment is indicated on the tags, but additional features as well. For example, a geographical segment can be tagged not only for the location it illustrates, but also for the historical relevance of the illustrated location.

In some embodiments the assets are provided in a searchable format. A searchable format can be conveniently searched by a search engine. Intelligent tagging can facilitate an efficient searchable format for the assets. For example, a segment of a geographical asset can be also tagged as the location of a battlefield besides its geographical importance. A search performed with the term “battlefields” will be able to locate this segment because of the intelligent tagging. The search engine returning this result enables the user of the system to author an asset on historical battlefields.

In some embodiments certain segmented audio-visual assets can be treated logically as unsegmented. On one hand the segmenting makes the assets easier to search, on the other hand treating them as unsegmented makes the processing of the assets efficient.

The authoring tools can also provide the users of the method with an intelligent template. The intelligent template can provide a template for authoring an educational interactive media or an entertainment interactive media. An example of a template for an educational media can be an outline of a class presentation. The outline may suggest to the user, such as a teacher, to start with an introduction, to provide an outline of the presentation, to provide a portion of the authored assets, then to summarize what has been presented so far, ask for questions and so on. The user can develop her/his own contributed asset using the outline of the intelligent template.

In some embodiments, where the facilities do not support fast Internet connections, such as individual subscriber's lines, or classrooms with slow modems, the bandwidth intensive audio-visual assets can be provided from a local database. On the other hand the text assets can be provided through the Internet.

In some embodiments the text assets are provided in different languages. In these embodiments the user of the system can select the language of the text asset.

In some embodiments the authored assets can be provided in a special format. Examples of suitable special formats are the ViMedia format, and the Ohana Media Format.

The described steps of the method are useful for the preparation of the authored assets. In additional steps, the prepared authored assets can be assembled in various ways. For example, if several users develop their own authored assets concerning the same topic, then these authored assets can be assembled into a larger, more concise asset. In some embodiments the assembly of assets can include automated steps, distributed steps, and collaborative steps.

For example, in collaborative steps, the authors of the various authored assets are encouraged to interact with each other to critique and develop their authored assets together.

Furthermore, the authored and assembled assets are distributed in various ways. The distribution can be peer-to-peer distribution, remote or local distribution, broad-band or narrow-band distribution. The distribution may utilize a scalable architecture, a multi-platform distribution, a multi-device distribution, a multi-language distribution, and a multi-level distribution.

### EXAMPLE 1

In an exemplary embodiment of the system for authoring an Electronic Curriculum System, an asset provider may produce a library of editable audio-visual assets for purposes of instruction in elementary schools. The editable audio-visual assets are digitized, for example, in a DVD format. The library may include material, which would fill up several hundred DVDs. The editable audio-visual assets of the library are uploaded on a central server system. Digitization of the editable audio-visual assets allows for storing the editable audio-visual assets in a compressed format, which uses space efficiently. The central server system distributes the content of the library to distributed servers, which are located so as to serve groups of elementary schools efficiently. Compression also allows the efficient transfer of the assets over low speed connections.

At a particular school a teacher reviews the editable audio-visual assets provided by the distributed server of the asset provider. The teacher finds parts of the provided editable audio-visual assets useful for instructional purposes. However, the teacher knows the specific circumstances and background of her/his students and therefore wishes to add additional text-based information to the editable audio-visual assets. Moreover, the teacher wishes to integrate her/his own text with the editable audio-visual assets and store it, creating her/his own electronic curriculum system. To this end, the teacher utilizes method 100 for creating an Electronic Curriculum System.

The teacher can host and open the authoring tools on her/his own computer. The teacher creates texts using the authoring tools, highlighting the central points of the studied subject matter and providing additional commentary and complementary information. The created texts include information, which were not contained in the editable audio-visual assets of the asset provider. Therefore, the teacher-created texts constitute additional useful information and are referred to as contributed assets. The contributed asset may contain instructional media in any format, including text, audio, video, and graphic formats.

The teacher can download from the Internet the chosen editable audio-visual assets to her/his own computer and integrate the downloaded editable assets with the contributed assets into authored assets. In doing so, the teacher makes use of the segmenting and intelligent tagging of the segments. The teacher can then present the authored assets for educational purposes in the classroom.

In other examples, the teacher can log on the Internet in the classroom. In this case the teacher presents the contributed text assets from her/his own computer on part of the display monitor, and uses other parts of the display monitor for showing the editable assets directly from the Internet. In this example the authored asset is created in the classroom directly.

The authored audio-visual assets may carry high educational value, and other teachers may want to use them. In this case, the teacher provides the authored assets to the asset provider through the Internet. The asset provider has the authored audio-visual assets reviewed by appropriate authorities and a quality assessment process. After possible improvements and corrections by the asset provider or the authorities, the authored audio-visual assets are made available by the asset provider for other users of the electronic curriculum system.

With the described authoring system of the electronic curriculum the asset provider can make available several alternative presentations of the same general topic. In this example, teachers can choose the presentation (authored audio-visual asset), which suits the needs, preparation, and background of their students the most.

In other aspects, the same editable asset can be used in several different authored assets. For example, an editable audio-visual asset about Mount Olympos in Greece can have an intelligent tag associated with it to record its possible relevance in geography, history, and mythology. In an example, a teacher, preparing a presentation on mythology, performs a search with the search term “Greek Gods”. The search engine locates the intelligent tag associated with “Mount Olympos”, and returns this result for the teacher. The teacher then includes the audio-visual asset about Mount Olympos into her presentation on the mythology of Greek Gods.

### EXAMPLE 2

Electronic curriculum systems can be authored without an Internet connection as well. In one example, the asset provider provides the library of the editable audio-visual assets on DVDs, or ViDVDs. An elementary school purchases the DVD library and makes it available for its teachers. One of the teachers selects the DVDs, which are closest to her/his topic and reviews them. Then the teacher selects suitable segments from a DVD, which can be extracted easily because the segments have intelligent tagging. The intelligent tags are associated with the segments based on their primary content as well as on additional information.

The DVDs can be made searchable as well. For example, the teacher may want to author a presentation on the contributions of Asian-Americans to U.S. history. However, the available DVD presents U.S. history in chronological order. The authoring tools provide search engines, which can search the DVD on U.S. history for segments, which make reference to the contributions of Asian-Americans. For example, the intelligent tag of the segments can list such additional information. The search engine then lists the results of the search in a user-friendly manner. Based on the listed search results, the teacher can organize the segments into an authored asset on Asian-American history.

The teacher can also integrate the editable segments with her/his own contributed text with ease, as the authoring tool provides drop-down menus to facilitate easy editing. The menus offer, for example, to zoom in, zoom out, or slow down a video segment. Other menus allow the addition of labels and legends to the editable graphics asset. Yet other menus allow the subtitling of video assets in different languages, as well as the addition of additional audio tracks in different languages.

Next the teacher uses an intelligent template, which is part of the authoring system, to create her/his own contributed text asset. The intelligent template suggests several possible outlines for an efficient presentation of the material for the teacher. The teacher forms an authored asset by combining the extracted editable asset with her/his own contributed text asset. The authored asset is saved and presented in the classroom at a later time.

Although the present method and its advantages have been described in detail, it should be understood that various changes, substitutions, and alterations can be made therein without departing from the spirit and scope of the method as defined by the appended claims. That is, the discussion included in this application is intended to serve only as a basic description. It should be understood that the specific discussion may not explicitly describe all embodiments possible; many alternatives are implicit. It also may not fully explain the generic nature of the method and may not explicitly show how each feature or element can actually be representative of a broader function or of a great variety of alternative or equivalent elements. Again, these are implicitly included in this disclosure. Neither the description nor the terminology is intended to limit the scope of the claims.

What is claimed is:

1. A method of providing an educational and training system, the method comprising:
providing editable audio-visual assets; and
providing automated tools for authoring an audio-visual asset, wherein the authoring comprises
editing one or more editable audio-visual assets and one or more contributed audio-visual assets into an authored audio-visual asset.

2. The method of claim 1, wherein the editable audio-visual assets comprise at least one of:
text assets, video assets, audio assets, and graphic assets.

3. The method of claim 2, wherein at least one of the text assets, video assets, audio assets, and graphic assets are digitized.

4. The method of claim 2, wherein at least one of the editable audio-visual assets are compressed.

5. The method of claim 4, wherein the at least one of compressed audio-visual assets comprise video assets in MPEG format.

6. The method of claim 1, wherein at least one of the editable audio-visual assets, the contributed audio-visual assets, and the authored audio-visual assets comprise interactive media.

7. The method of claim 1, comprising
providing the editable audio-visual assets as at least one of a DVD-Video, a DVD-ROM, and a ViDVD.

8. The method of claim 1, comprising
providing at least one of the editable audio-visual assets, the contributed audio-visual assets, and the authored audio-visual assets in a format supporting the authoring of audio-visual assets through editing menus.

9. The method of claim 8, wherein the authoring of audio-visual assets is performed essentially automatically.

10. The method of claim 1, comprising
providing the editable audio-visual assets via an Internet by an asset provider.

11. The method of claim 10, comprising
providing the editable audio-visual assets via an Internet by the asset provider using distributed servers.

12. The method of claim 10, comprising
providing the authored audio-visual assets as editable audio-visual assets via an Internet by the asset provider.

13. The method of claim 12, comprising
providing the authored audio-visual assets as editable audio-visual assets by the asset provider by at least one of
uploading the authored audio-visual assets into a server and providing a hyperlink/universal resource locator on a server.

14. The method of claim 1, comprising
segmenting at least one of the contributed audio-visual asset and the editable audio-visual assets; and
intelligently tagging the segmented audio-visual assets.

15. The method of claim 14, comprising
providing the intelligently tagged segmented audio-visual assets in a searchable format.

16. The method of claim 14, wherein the intelligent tagging comprises
associating with the audio-visual asset searchable information about the audio-visual asset.

17. The method of claim 14, wherein a segmented audio-visual asset is logically treated as unsegmented.

18. The method of claim 1, wherein the providing of automated tools for authoring audio-visual assets comprises
providing an intelligent template.

19. The method of claim 18, wherein
the intelligent template comprises an outline for authoring at least one of an educational interactive media and an entertainment interactive media.

20. The method of claim 1, comprising
providing bandwidth intensive audio-visual assets from a local storage; and
providing text assets through the Internet.

21. The method of claim 1, comprising
providing at least one of the text, audio, and graphics assets in different languages.

22. The method of claim 1, comprising
providing editable audio-visual assets hyper-linked to video assets.
